(19) United States
(12) Patent Application Publication
(10) Pub. No.: US 2010/0103091 A1
(43) Pub. Date: Apr. 29, 2010

(54) LIGHT EMITTING DIODE ARRAY, DRIVING SYSTEM THEREOF AND LIQUID CRYSTAL DISPLAY USING THE SAME

(75) Inventors: IRENE CHEN, TAOYUAN COUNTY (TW); KUAN HER CHIU, CHANGHUA COUNTY (TW); JIAN SHIHN TSANG, TAIPEI COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: ADVANCED OPTOELECTRONIC TECHNOLOGY INC., HSINCHU COUNTY (TW)

(21) Appl. No.: 12/607,387

(22) Filed: Oct. 28, 2009

(30) Foreign Application Priority Data
Oct. 29, 2008 (TW) 097141534

(51) Int. Cl. G09G 3/36

(52) U.S. Cl. 345/102

(57) ABSTRACT

A light emitting diode array for a liquid crystal display comprises a plurality of first light emitting diodes that are driven by pulse-width modulated signals and a plurality of second light emitting diodes that are driven by constant direct current. The plurality of first light emitting diodes and the plurality of second light emitting diodes are arranged in an alternating manner for adjustment of the uniform illumination of a liquid crystal display.

### BACKGROUND OF THE INVENTION

1. Field of the Invention

The present invention relates to a light emitting diode array, and relates more particularly to a light emitting diode array for a liquid crystal display.

2. Description of the Related Art

Cold cathode fluorescent lamps have traditionally been used as the light sources of liquid crystal displays. Due to their inclusion of mercury, the cold cathode fluorescent lamps are known to cause environmental pollution. In addition, cold cathode fluorescent lamps have issues of slow response rate and poor color reproducibility, and limit the reduction of weight and volume of liquid crystal displays. Moreover, cold cathode fluorescent lamps need high activation and operating voltage, and the light sources in the backlight modules of liquid crystal displays consume most of the display power. Therefore, as the power usage becomes strictly limited, cold cathode fluorescent lamps have gradually been replaced by light emitting diodes.

Compared to cold cathode fluorescent lamps, light emitting diodes are environmentally friendly and have shorter response times in the range of several nanoseconds so that they can transmit video signals more efficiently. In addition, light emitting diodes can be driven using pulse signals and have total or near-total color reproducibility. Moreover, the light emission of red, green and blue light emitting diodes can be adjusted for the change of luminosity and color temperature. Light emitting diodes have also an advantage of reduction of the weight and volume of a crystal liquid display. Therefore, light emitting diodes are progressively adopted as the light source of the backlight module of a liquid crystal display.

Light emitting diodes are droved by electric current, and their brightness is proportional to the forward current flowing thereto. Two methods can be used to drive light emitting diodes.

In the first method, light emitting diodes are driven based on their V-I characteristic curve. Generally, a power supply and a rectifiable resistor are used to provide light emitting diodes with desired voltage. However, the method has some drawbacks. For example, the variation of the forward voltage changes the current flowing to light emitting diodes.

Assuming that voltage is 3.6 volts and current is 20 mini-amps, the current may vary 30% due to the temperature or manufacturing variations causing specific change in voltage when the voltage is 4.0 volts. Greater changes in forward voltage cause greater change in forward current. Further, voltage drop and power consumption may waste power and reduce the life span of light emitting diodes.

In the second method, light emitting diodes can be driven using constant current. Using constant current can avoid the current change caused by the change in forward voltage, and therefore, the brightness of light emitting diodes can be maintained. Constant current can be supplied by adjusting the voltage of a current detection resistor device, and the output voltage of a power supply need not be adjusted. The power supply voltage and the resistance of the current detection resistor device determine the current supplied to light emitting diodes. When multiple light emitting diodes are driven, the constant current can be obtained by serially connecting the multiple light emitting diodes.

Additionally, the backlight modules of most liquid crystal displays need the adjustment of brightness thereof. Two methods, an analogous method and a pulse-width modulation method, can be applied for this purpose. It is well known that the analogous method can increase brightness by 50 percent by increasing current flowing to light emitting diodes by 50 percent. However, the analogous method has drawbacks in that light emitting diodes may exhibit color shift and need analogous control signals. Thus, this method is rarely adopted.

The pulse-width modulation method is more popular and is a preferred method for the brightness adjustment of light emitting diodes. The pulse-width modulation method becomes more popular as the use of digital control logic circuits increases. The pulse-width modulation method is simple and can be adopted to be similar to the analogous method using digital control logic circuits.

FIG. 1 shows a simple circuit for generating pulse-width modulation signals for driving light emitting diodes and the waveform of a pulse-width modulation signal. When the circuit is turned on, the waveform goes high, and when the circuit is turned off, the waveform goes low.

If the time period during which the circuit is turned on is reduced, light emitting diodes become dimmer. As shown in FIG. 1, light emitting diodes are turned on for 50 percent of a cycle time, and are turned off during the other 50 percent. Utilizing repeating signals to control light emitting may result in division of a cycle time into pieces. In a cycle time, light emitting diodes can be turned on and off, if using a single cycle time. Signals can further be characterized by duty ratio, namely, the ratio of the ON time to a cycle time. If the duty ratio is higher, light emitting diodes are brighter; if the duty cycle is lower, light emitting diodes are dimmer.

The main concern for the use of the pulse-width modulation method for adjustment of brightness is that the frequency of the pulse-width modulation has to be greater than 100 MHz to ensure that the effects of the pulse-width modulation method are invisible to users.

As mentioned above, many publications have provided different pulse-width modulation technologies to control the brightness of the light emitting diodes used in a backlight module for increasing the light output efficiency and maintaining the illumination uniformity of the backlight module. In addition, some methods, as disclosed in U.S. Patent Publication No. 2007/0,091,057 and European Patent Publication No. 1,780,701, can lower temperature and reduce energy consumption of a backlight module.

Further, Chinese Patent Publication No. 101,013,559 discloses a circuit for controlling the brightness of light emitting diodes. The method drives at least one pair of light emitting diodes using pulse-width modulated signals independently without affecting the brightness of other light emitting diodes.

However, the pulse-width modulation method requires pulse-width modulation integrated circuits to adjust brightness of light emitting diodes, and as the number of light emitting diodes increases, the number of the pulse-width modulation integrated circuits also increases, resulting in high manufacturing cost and complex design of driving system of a backlight module.

### SUMMARY OF THE INVENTION

According to the discussion in the Description of the Related Art and to meet the requirements of the industry, the present invention provides a liquid crystal display including a light emitting diode array to solve the above-mentioned issues.

One objective of the present invention is to provide a light emitting diode array configured for a liquid crystal display. The light emitting diode array comprises a plurality of first light emitting diodes driven by pulse-width modulated signals and a plurality of second light emitting diodes driven by constant direct current, wherein at least one light emitting diode is included in an adjusting light module to adjust the brightness of the liquid crystal display, and at least one second light emitting diode is included in a constant light module to constantly emit light for the liquid crystal display. The adjusting light module and the constant light module are arranged in an interlacing manner.

Another objective of the present invention is to provide a light emitting diode driving system configured for a liquid crystal display. The light emitting diode driving system comprises a plurality of channels of adjusting light area, a plurality of channels of constant light area, a plurality of pulse-width modulation integrated circuits, and a constant current source. Each channel of adjusting light area includes a plurality of serially connected adjusting light modules and each channel of constant light area includes a plurality of serially connected constant light modules, wherein the plurality of adjusting light modules and the plurality of constant light modules are arranged in an alternating manner. Each pulse-width modulation integrated circuit is configured to supply pulse-width modulated signals to a portion of said one or more channels of adjusting light area so as to adjust the brightness of said first light emitting diode. The constant current source supplies stable current to the plurality of channels of constant light area for maintaining constant brightness of the at least one second light emitting diode.

Another objective of the present invention is to provide a liquid crystal display, which comprises a liquid crystal panel and the above-mentioned light emitting diode driving system, wherein the pulse-width modulation integrated circuits supply pulse-width modulated signals in response to brightness adjustment signals to adjust the brightness of the first light emitting diode so as to achieve uniform brightness of the liquid crystal panel.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIG. 1 is a schematic view showing a simple circuit for generating pulse-width modulation signals for driving light emitting diodes and the waveform of a pulse-width modulation signal;

FIGS. 2A to 2C are schematic views showing a plurality of adjusting light modules arranging in an alternating manner and constant light modules according to one embodiment of the present invention;

FIG. 3 is a schematic view showing the light emitting diode driving system of a liquid crystal display according to one embodiment of the present invention;

FIGS. 4A and 4B are schematic views showing traditional light emitting diode driving circuits; and

FIG. 5 is a schematic view showing a liquid crystal display according to one embodiment of the present invention.

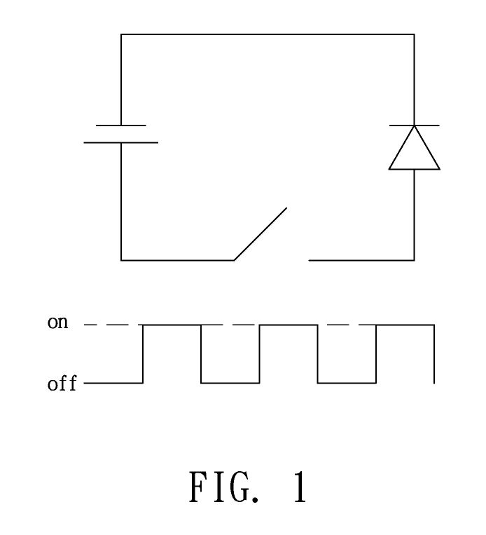

### DETAILED DESCRIPTION OF THE INVENTION

One aspect that the present invention discusses is a light emitting diode array. In order to thoroughly understand the present invention, detailed descriptions of method steps and components are provided below. Clearly, the implementations of the present invention are not limited to the specific details that are familiar to persons skilled in the art related to a light emitting diode array. In addition, components or method steps which are well known are not described in detail. A preferred embodiment of the present invention is described in detail. However, in addition to the preferred detailed description, other embodiments can be broadly employed, and the scope of the present invention is not limited by any of the embodiments, but should be defined in accordance with the following claims and their equivalent.

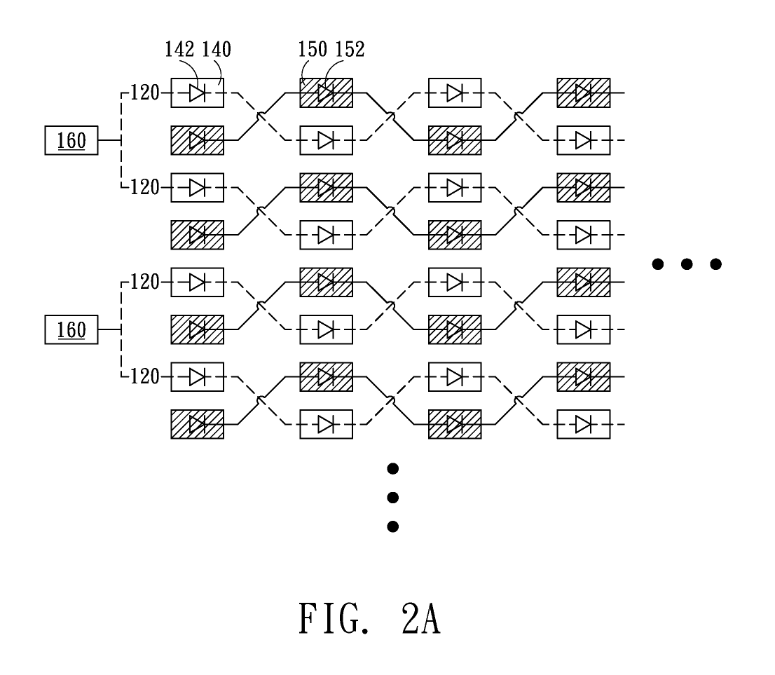

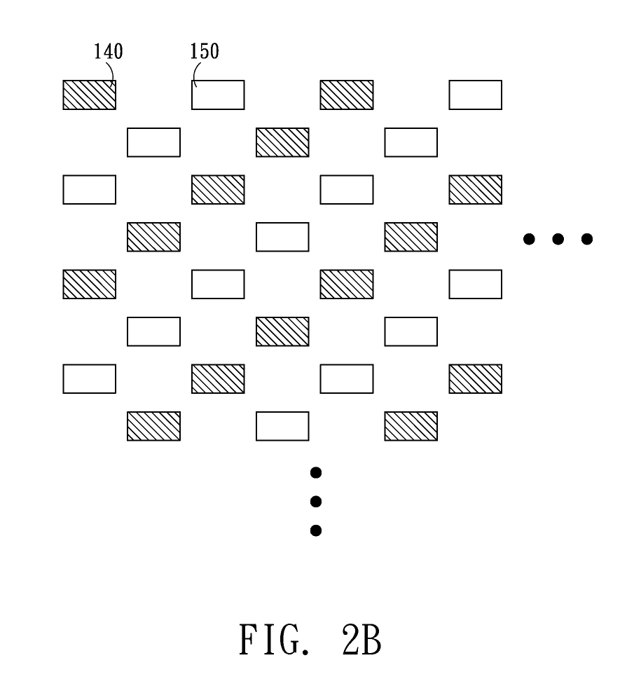

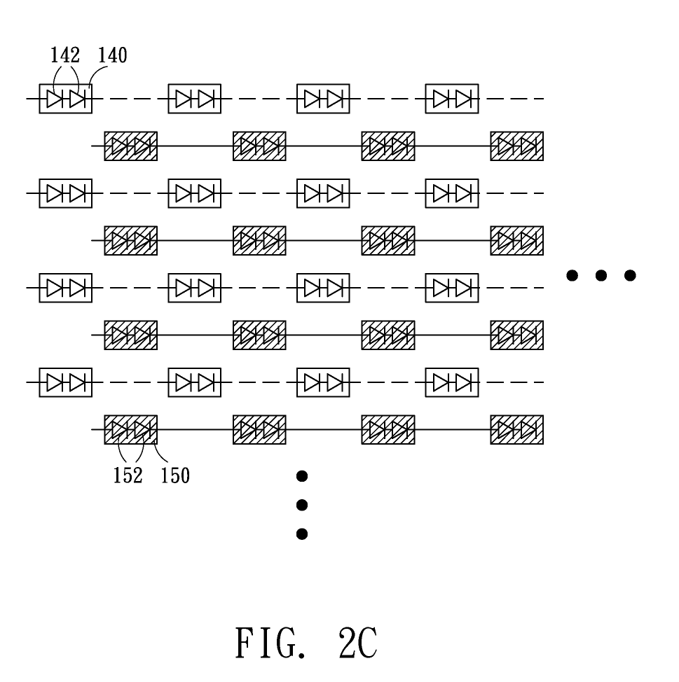

In order to adjust and maintain the basic brightness of a liquid crystal display, the present invention proposes a light emitting diode array for a liquid crystal display 100 as shown in FIG. 2A. The light emitting diode array comprises one or more first light emitting diodes 142 driven by pulse-width modulated signals and one or more second light emitting diodes 152 driven by constant direct current, wherein at least one first light emitting diode 142 is included in an adjusting light module 140, and at least one second light emitting diode 152 is included in a constant light module 150.

In order to adjust the illumination uniformity of a liquid crystal display, the adjusting light module 140 and the constant light module 150 are arranged in an interlacing manner as shown in FIGS. 2A, 2B, and 2C. FIG. 2A shows a plurality of adjusting light modules 140 and a plurality of constant light modules 150 arranged in alternating manner along both the longitudinal and transverse directions, wherein one constant light module 150 is disposed between every two adjusting light modules 140.

FIG. 2B shows a plurality of adjusting light modules 140 and a plurality of constant light modules 150 arranged in alternating manner along both the longitudinal and transverse directions. In the transverse direction, the arrangement of the adjusting light modules 140 and the constant light modules 150 is similar to that shown in FIG. 2A. However, in the longitudinal direction, the distances between the adjusting light modules 140 and the constant light modules 150 are greater than those along the transverse direction. In one preferred embodiment of the present invention, the spacing between each adjusting light module 140 and the adjacent constant light module 150 in the longitudinal direction is twice than that in the transverse direction.

FIG. 2C shows a plurality of adjusting light modules 140 and a plurality of constant light modules 150 arranged in alternating manner in an oblique direction. In other words, along an oblique direction, a constant light module 150 is disposed between every two adjusting light modules 140. Furthermore, according to different objectives of light adjustment, the present invention can include other alternative arrangements of light emitting diodes, and are not limited to the embodiments in the above-mentioned figures. The alternating arrangement of light emitting diodes proposed by the present invention can simplify the driving system for a backlight module and lower integrated circuit manufacturing cost.

The light emitting diode array can further comprise one or more pulse-width modulation integrated circuits 160, wherein each pulse-width modulation integrated circuit 160 is configured to supply pulse-width modulated signals to one or more channels of adjusting light area 120, and each adjusting light area 120 comprises one or more serially connected adjusting light modules 140. If one light emitting diode in serially connected adjusting light modules 140 fails, the design of the present invention can locally blur a bright band.

In addition to the embodiment of FIG. 2A wherein each adjusting light module 140 and each constant light module 150 separately comprise a first light emitting diode 142 and a second light emitting diode 152, each adjusting light module 140 can further comprise a plurality of serially connected first light emitting diodes 142, and each constant light module 150, as well, can comprise a plurality of serially connected second light emitting diodes 152. In another preferred embodiment of the present invention, the adjusting light module 140 can include two first light emitting diodes 142, and the constant light module 150 can include two second light emitting diodes 152 as shown in FIG. 2C.

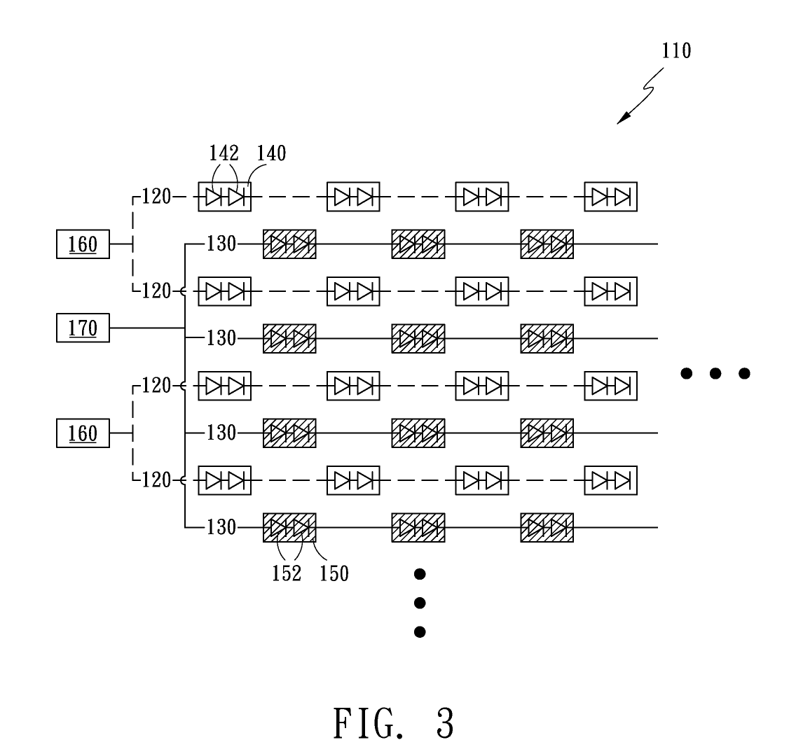

Referring to FIG. 3, the present invention further proposes a light emitting diode driving system 110 configured for a liquid crystal display 100. The light emitting diode driving system 110 comprises a plurality of channels of adjusting light modules 120, a plurality of channels of constant light module 130, a plurality of pulse-width modulation integrated circuits 160 and a constant current source 170. Each channel of adjusting light module 120 comprises at least one serially connected adjusting light module 140, each of which includes at least one first light emitting diode 142, wherein each pulse-width modulation integrated circuit 160 supplies pulse-width modulated signals to a portion of the plurality of channels of the adjusting light module 120 to adjust the brightness of the at least one first light emitting diode 142.

Each channel of constant light modules 130 comprises a plurality of serially connected constant light modules 150, each of which comprises at least one second light emitting diode 152, wherein the constant current source 170 constantly supplies current to the plurality of channels of constant light module 130 so as to maintain constant brightness of the at least one second light emitting diode 152. Furthermore, the plurality of adjusting light modules 140 and the plurality of constant light modules 150 can be alternately arranged for different light adjustment purposes.

As mentioned above, if the backlight module of a liquid crystal display uses a plurality of serially connected light emitting diodes, a driving circuit is required to supply the light emitting diodes with constant current. Specifically, when a user wishes to adjust brightness and color temperature or make temperature compensation, an adjusting light circuit is required for adjusting brightness. A DC-DC converter usually uses a pulse-width modulation mechanism to control a conductive element. Such a technique may change a loading cycle, namely, the ratio of the on to off time of a transistor, in conjunction with an inductance, which is capable of storing electrical power, so that the output voltage can be fixed within a limited range of input voltage and loading current.

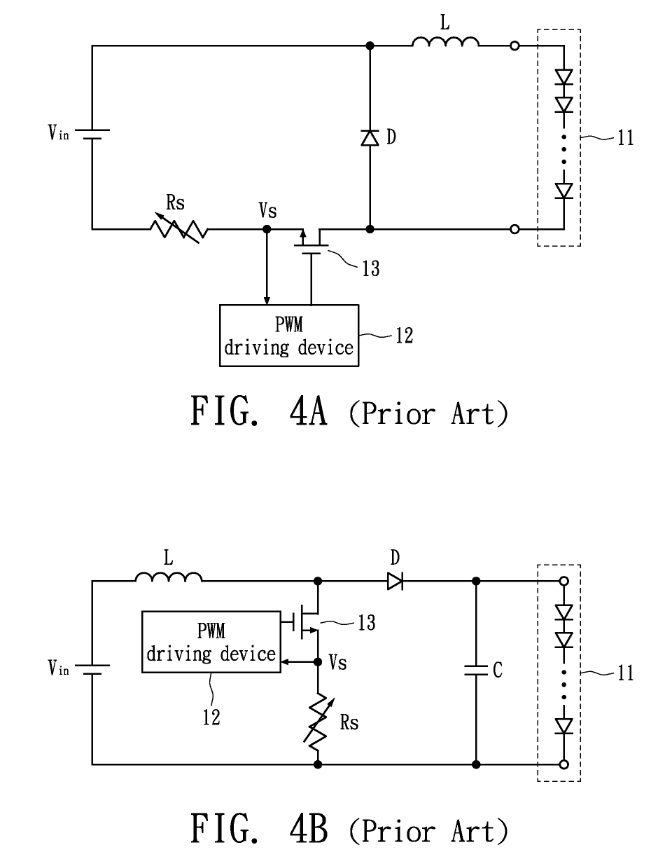

FIGS. 4A and 4B show traditional driving circuits for light emitting diodes. FIG. 4A shows a traditional buck DC-DC converter in a light emitting diode driving circuit. As shown in FIG. 4A, the light emitting diode driving circuit includes a traditional buck DC-DC converter. An inductance L and a light emitting diode array 11 are serially connected to the positive voltage terminal of a direct current source Vᵢₙ. A diode D and the inductance L or the light emitting diode array 11 are connected in parallel. In addition, a switch 13 and voltage detection resistor Rs are serially connected from the connection point, between the light emitting diode array 11 and the diode D, to the negative voltage terminal of the direct current source Vᵢₙ. The detected voltage across the voltage detection resistor Rs is outputted to the pulse-width modulation driving device 12, and according to the voltage value, the duty ratio for the switch 13 is adjusted. As shown in FIG. 4A, the switch 13 can be a metal oxide semiconductor field effect transistor (MOSFET). When switching pulse signals are applied to the gate of the MOSFET, the MOSFET can be used as a switch.

When the switch 13 is turned on, the direct current source Vᵢₙ supplies current to the light emitting diode array 11 through the inductance L. Simultaneously, the inductance L accumulates energy. When the switch 13 is turned off, the energy accumulated in the inductance L is supplied to the light emitting diode array 11. According to the voltage, which the voltage detection resistor Rs supplies to the light emitting diode array 11, the pulse-width modulation driving device 12 adjusts the duty ratio for the switch 13.

FIG. 4B shows a traditional boost DC-DC converter for a light emitting diode driving circuit. As shown in FIG. 4B, the light emitting diode circuit includes a traditional boost DC-DC converter. An inductance L and a diode D are serially connected to the positive voltage terminal of a direct current source Vᵢₙ. A capacitor C and the light emitting diode array 11 are connected in parallel between the diode D and the negative voltage terminal of the direct current source Vᵢₙ. The switch 13 and the voltage detection resistor Rs are serially connected from the connection point, between the inductance L and the diode D, to the negative voltage terminal of the direct current source Vᵢₙ. The detected voltage across the voltage detection resistor Rs is outputted to the pulse-width modulation driving device 12, and according to the voltage value, the duty ratio for the switch 13 is adjusted. As shown in FIG. 4B, the switch 13 can be a MOSFET. When switching pulse signals are applied to the gate of the MOSFET, the MOSFET can be used as a switch.

When the switch 13 is turned on, the current supplied by the direct current source Vᵢₙ flows through the inductance L and the switch 13, and energy is stored in the inductance L. When the switch 13 is turned off, the energy accumulated in the inductance L is supplied with the energy in the direct current source Vᵢₙ to the light emitting diode array 11 through the diode D. Herein, the smooth capacitor C smoothes the voltage to the light emitting diode array 11, and the smoothed voltage is greater than or equal to the input voltage Vᵢₙ.

In such a light emitting diode driving circuit, adjusting the resistance of the voltage detection resistor Rs to change the voltage across the voltage detection resistor Rs can adjust the duty ratio for the switch 13 so as to change the brightness of the light emitting diodes.

U.S. Patent Publication No. 2008/0,002,102 provides a liquid crystal display backlight driving system with light emitting diodes. The system includes a switch mode power supply, which includes an AC-DC converter for converting an externally inputted AC voltage to a DC voltage and DC-DC converters for converting the DC voltage to a predetermined magnitude of DC voltage for driving LED arrays.

Moreover, Japanese Patent Publication No. JP2007013183 provides an LED drive circuit for a backlight with constant current control function. A PWM controls the on/off of the switch, and outputs a switching pulse to a MOSFET according to a duty ratio determined by prearranged internal reference voltage and detection voltage detected by the voltage detecting resistor using a comparator.

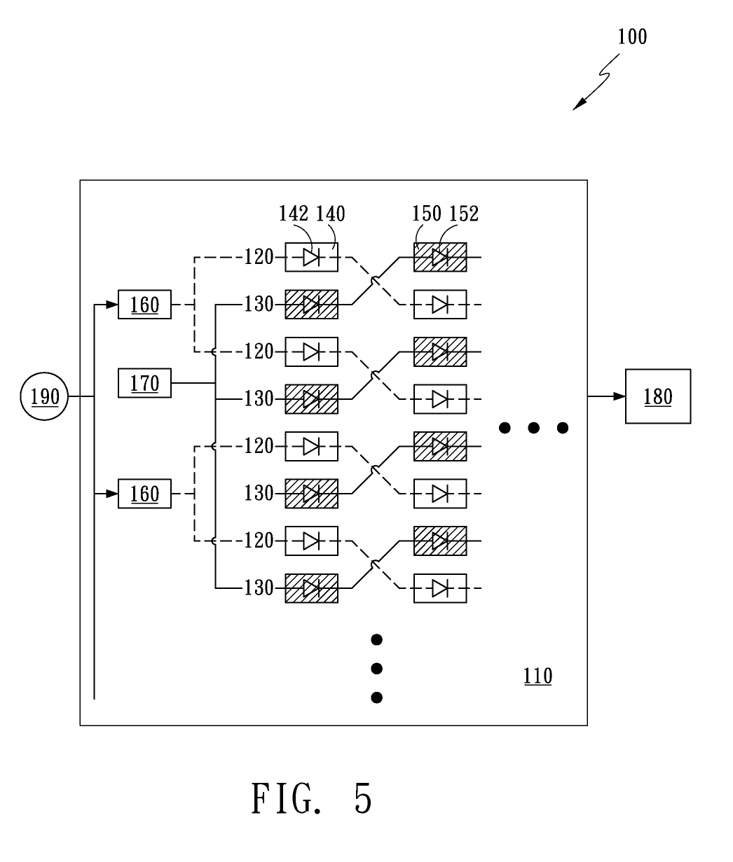

Referring to FIG. 5, the present invention further provides a liquid crystal display 100, which comprises a light emitting diode driving system 110 and a liquid crystal panel 180. The light emitting diode driving system 110 comprises a plurality of channels of adjusting light module 120, a plurality of channels of constant light module 130, a plurality of pulse-width modulation integrated circuits 160 and a constant current source 170.

When the pulse-width modulation integrated circuits 160 receive brightness adjustment signals 190, the pulse-width modulation integrated circuits 160 supplies pulse-width modulated signals to a portion of the plurality of channels of adjusting light module 120 to adjust the brightness of the at least one first light emitting diode 142. For example, when a user wishes to adjust the brightness of a liquid crystal display, the liquid crystal display sends a brightness control signal to the pulse-width modulation integrated circuits.

When the pulse-width modulation integrated circuits 160 adjust the brightness of the at least one first light emitting diode 142, the constant current source 170 supplies stable current to the at least one second light emitting diode 152 so that the plurality of channels of constant light module 130 maintain constant brightness. Therefore, the ratio of the number of the first light emitting diodes 142 to the number of the second light emitting diodes 152 determines the lowest brightness of the liquid crystal display 100 while adjusting.

For example, when the ratio of the first light emitting diodes 142 to the second light emitting diodes 152 is 1:1 and if the first light emitting diodes 142 are turned off using the pulse-width modulation integrated circuit 160, the remaining second light emitting diodes 152 emit light and the brightness level of the liquid crystal display 100 is reduced to 50%.

Furthermore, the first light emitting diodes 142 and the second light emitting diodes 152 illuminate the liquid crystal panel 180. The adjusting light module 140 and the constant light module 150 can be arranged in alternating manner for uniform illumination of the liquid crystal panel 180.

Generally, the liquid crystal display 100 can include an edge-type backlight module or a direct-type backlight module. The former has a light source disposed beside an edge of a light guide for illuminating the display panel of the liquid crystal display 100, while the later has a surface light source having a size similar to that of the display panel and disposed beneath the display panel for illuminating the display panel. The light emitting diode array preferably is for a direct-type liquid crystal display.

The above-described embodiments of the present invention are intended to be illustrative only. Numerous alternative embodiments may be devised by persons skilled in the art without departing from the scope of the following claims.

What is claimed is:

1. A light emitting diode array configured for a liquid crystal display, comprising:
at least one adjusting light module including at least one first light emitting diode configured to be driven by pulse-width modulated signals, said adjusting light module configured to adjust the brightness of said liquid crystal display; and
a constant light module including at least one second light emitting diode configured to be driven by constant direct current, said constant light module configured to constantly emit light for said liquid crystal display, wherein said adjusting light module and said constant light module are arranged in an interlacing manner.

2. The light emitting diode array of claim 1, wherein said liquid crystal display is a direct-type liquid crystal display.

3. The light emitting diode array of claim 2, further comprising a plurality of pulse-width modulation integrated circuits and one or more channels of adjusting light area, wherein each of said one or more channels of adjusting light area comprises said serially connected at least one adjusting light module, and each pulse-width modulation integrated circuit is configured to supply said pulse-width modulated signals to said one or more channels of adjusting light area.

4. The light emitting diode array of claim 2, wherein said at least one adjusting light module and said constant light module are arranged in an alternating manner, wherein said constant light module is disposed between any two of said at least one adjusting light module.

5. The light emitting diode array of claim 2, wherein each of said at least one adjusting light module comprises a plurality of serially connected first light emitting diodes.

6. The light emitting diode array of claim 2, wherein said constant light module comprises a plurality of serially connected second light emitting diodes.

7. A light emitting diode driving system configured for a liquid crystal display, comprising:
one or more channels of adjusting light area each including a plurality of serially connected adjusting light modules each including at least one first light emitting diode;
a plurality of pulse-width modulation integrated circuits, wherein each pulse-width modulation integrated circuit is configured to supply pulse-width modulated signals to a portion of said one or more channels of adjusting light area so as to adjust the brightness of said first light emitting diode;
one or more channels of constant light area each including one or more serially connected constant light modules each including at least one second light emitting diode, wherein said plurality of adjusting light modules and said one or more serially connected constant light modules are arranged in an interlacing manner; and
a constant current source constantly supplying current to said one or more channels of constant light area for maintaining constant brightness of said at least one second light emitting diode.

8. The light emitting diode driving system of claim 7, wherein said liquid crystal display is a direct-type liquid crystal display.

9. The light emitting diode driving system of claim 8, wherein said plurality of adjusting light modules and said one or more constant light modules are arranged in an alternating manner, wherein one of said one or more constant light modules is disposed between each pair of adjusting light modules.

10. The light emitting diode driving system of claim 8, wherein each of the said plurality of adjusting light modules comprises a plurality of serially connected first light emitting diodes.

11. The light emitting diode driving system of claim 8, wherein each of the said one or more constant light modules comprises a plurality of serially connected second light emitting diodes.

12. A liquid crystal display, comprising:
a liquid crystal panel; and
a light emitting diode driving system disposed adjacent to said liquid crystal panel, comprising:
one or more channels of adjusting light area each including a plurality of serially connected adjusting light modules each including at least one first light emitting diode;
a plurality of pulse-width modulation integrated circuits, wherein each pulse-width modulation integrated circuit is configured to supply pulse-width modulated signals to a portion of said one or more channels of adjusting light area so as to adjust the brightness of said first light emitting diode;
one or more channels of constant light area each including one or more serially connected constant light modules each including at least one second light emitting diode, wherein said plurality of adjusting light modules and said one or more serially connected constant light modules are arranged in an interlacing manner; and
a constant current source supplying steady current to said one or more channels of constant light area for maintaining constant brightness of said at least one second light emitting diode;
wherein said plurality of adjusting light modules and said one or more constant light modules are arranged in an interlacing manner, thereby achieving uniform illumination of said liquid crystal panel.

13. The liquid crystal display of claim 12, wherein the said liquid crystal display is a direct-type liquid crystal display.

14. The liquid crystal display of claim 13, wherein the said plurality of adjusting light modules and the said one or more constant light modules are arranged in an alternating manner, wherein one of said one or more constant light modules is disposed between pairs of the adjusting light modules.

15. The liquid crystal display of claim 13, wherein each of the said plurality of adjusting light modules comprises a plurality of serially connected first light emitting diodes.

16. The liquid crystal display of claim 13, wherein each of the said one or more constant light modules comprises a plurality of serially connected second light emitting diodes.
